(19) United States
(12) Patent Application Publication
(10) Pub. No.: US 2003/0189546 A1
(43) Pub. Date: Oct. 9, 2003

(54) Control system and method in a computer environment

(76) Inventor: Thierry Lamouline, Guy de Maupassant (FR)

Correspondence Address: YOUNG & THOMPSON, 745 SOUTH 23RD STREET 2ND FLOOR, ARLINGTON, VA, 22202

(21) Appl. No.: 10/203,914

(22) PCT Filed: Feb. 16, 2001
(86) PCT No.: PCT/FR01/00477

(30) Foreign Application Priority Data
Feb. 17, 2000 (FR) 00/01963

(51) Int. Cl. G09G 5/00

(52) U.S. Cl. 345/156

(57) ABSTRACT

The invention concerns a system for controlling an operation and comprises a reader device and a digital processing unit (12) connected to the reader device. The reader device comprises an optical sensor (15) for reading a coded information (8) on the surface of which lies said device, said information being transmitted to a digital processing unit to trigger a computer operation.

The present invention relates to reading printed information in order to trigger operations in a computer system in a network such as the Internet or an intranet.

When a computer user finds out about a site that might interest him, for example in a newspaper or a magazine, he must key the address of the site on the keyboard of his computer to launch a URL request to open the site.

The document U.S. Pat. No. 5,909,209 (Lucent Technologies) describes a mouse which is connected by a cable to a computer and comprises a ball for detecting movement of the mouse relative to a surface over which it slides when moved by the hand of a user, a CCD or CMOS video camera with a lens, and illumination means. The video camera registers an image on an object a short distance below the mouse and generates a signal representative of the image. To use the mouse as a movement transducer the user must place it on a surface and to use the mouse as an image reader the user must keep it at a particular distance from the image to be read, which distance is determined by the optical characteristics of the video camera and the lens.

An object of the present invention is to provide a control system that is easy to use.

A system in accordance with one aspect of the invention for commanding an operation includes a reader device and a digital processor unit connected to the reader device. The reader device includes an optical sensor adapted to read coded information on a surface on which said device rests, said information being transmitted to the digital processor unit to trigger a computer operation. The information is coded in the form of a two-dimensional pictogram. The processor unit includes means for sending a control code to a database, on reception of said information. The database includes means for outputting an Internet request or an address in response to said control code. The output means can comprise means for presentation of an object designated by said control code.

It is therefore possible to launch a request for opening of a destination designated by said address or any other Internet or digital operation, in particular from the digital processor unit.

The device rests directly in contact with the surface carrying the image, which makes it easier for the user to use. The device comprises means for transmitting said information to the digital processor unit. The reader device and the digital processor unit can be connected by a cable, an infra red link, a radio link, etc. The digital processor unit can be a microcomputer, a telephone, etc.

In one embodiment of the invention, the reader device is part of a mouse having means for sensing movement relative to a surface.

In another embodiment of the invention, the reader device is part of a light pen.

In a further embodiment of the invention, the reader device is part of a telephone, for example a mobile telephone, a pager, a personal digital assistant, a remote controller, or a webcam. By “webcam” is meant a video camera, generally a digital video camera.

The pictogram can comprise basic elements of identical size.

In one embodiment of the invention, the pictogram comprises basic elements with the same dimensions on two axes.

The optical sensor is preferably a CMOS sensor.

The optical sensor is advantageously able to read coded information when it is immobile relative to said surface with the reader device in contact with said surface. Reading is effected with the reader device immobile, which is much more practical and reliable than reading by scanning, which involves moving the reader device. The optical sensor then forms static reading means. Failing this, the optical sensor (for example a 1×128-pixel CMOS strip) is adapted to read coded information only when moving relative to said surface.

The database can be located on another microcomputer on the same network or on a server and accessible via the Internet.

The invention also proposes a method of commanding an operation, in which a reader device, including an optical reader sensor, reads coded information in the form of a two-dimensional pictogram on a surface on which said device rests and transmits said information to a digital processor unit connected to said device to trigger a computer operation. On receipt of said information, the processor unit sends a control code to a database. In response to said control code, the external database sends back an Internet instruction.

In the present context the expression “control code” is to be understood in the widest possible sense. In other words, the processor unit sends information to the database and the database sends back data associated with said information.

For example, the information can be an Internet address, for example a URL, for launching a request to open a site.

The user has the benefit of a very simple way of opening Internet sites, comparable to using a hyperlink between two Internet sites. The invention proposes to provide the equivalent of a hyperlink between an image printed or marked on a mechanical support and a page of an Internet site.

The invention applies in particular to ordering goods or services on-line from a website, or to entering a telephone number or an electronic mail address. In this case, the coded information can be on a printed support, for example a label affixed to a product, or etched, and the user places the reader device (mouse, pen or telephone) on the medium to perform the reading operation. The coded information can also be on some other support, such as an advertisement page in a newspaper or magazine. The telephone number or the electronic mail address can then be stored for updating a directory.

According to one aspect of the invention, the reader device includes an optical sensor able to read coded information in the form of a two-dimensional pictogram in an area of a surface when said area is disposed in the field of the optical sensor, and means for transmitting said information to a digital processor unit. The device comprises illumination means for illuminating said area using ambient light.

In one embodiment of the invention, the illumination means comprise a translucent or transparent portion of a casing containing the optical sensor.

The device advantageously comprises aiming means for positioning the device correctly relative to the field of the optical sensor, which is fixed relative to the device.

In one embodiment of the invention, the aiming means comprise visual markings around and/or in the field of the optical sensor.

Means for focussing light, such as one or more lenses, can be placed on the optical path.

The translucent or transparent portion of the casing is a wall crossing the field of the optical sensor. Said wall can be plane or convex, solid (which prevents the ingress of foreign bodies or dirt) or pierced by a hole or a well with dimensions corresponding to the field of the optical sensor. In the latter case, the well has translucent or transparent walls.

On a solid wall, the visual markings can comprise a groove or a rib and/or markings that contrast with the wall, for example colored marks applied by screenprinting, other forms of printing, affixing an adhesive element, etc.

The device can comprise means for artificially illuminating said area using light-emitting diodes (LEDs). However, given the ability of CMOS sensors to control exposure time and gain automatically, this lighting is not always required, ambient lighting being sufficient on its own.

The invention also proposes a computer program product including program code means for implementing the steps of the above method when said program is executed on a computer.

The invention also proposes a medium capable of being read by a device for reading program code means stored therein and adapted to implement the steps of the above method when said program is executed on a computer.

The present invention will become clearer and other advantages will become apparent on reading the detailed description of a few embodiments provided by way of non-limiting example and shown in the accompanying drawings, in which:

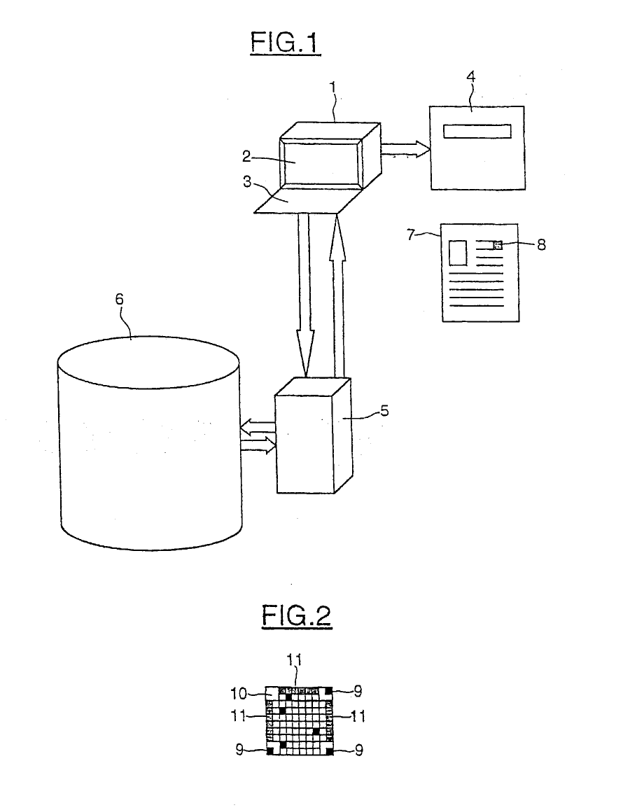

FIG. 1 is a diagrammatic view of a pictogram generator system,

FIG. 2 is a plan view to a larger scale of one example of a pictogram,

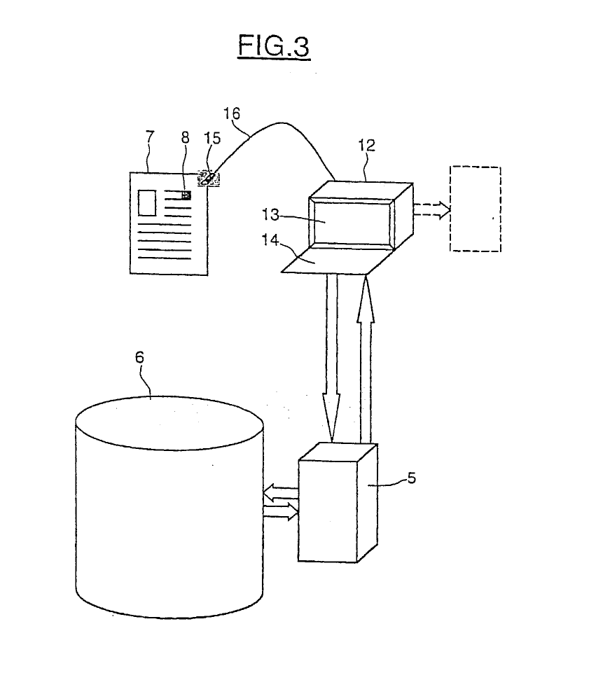

FIG. 3 is a diagrammatic view of a system for reading and interpreting a pictogram,

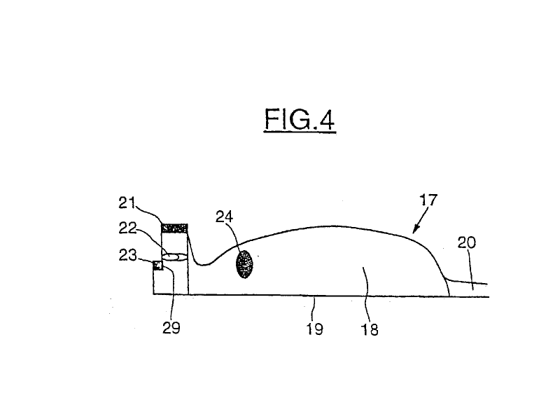

FIG. 4 is a diagrammatic view of a mouse provided with an optical sensor,

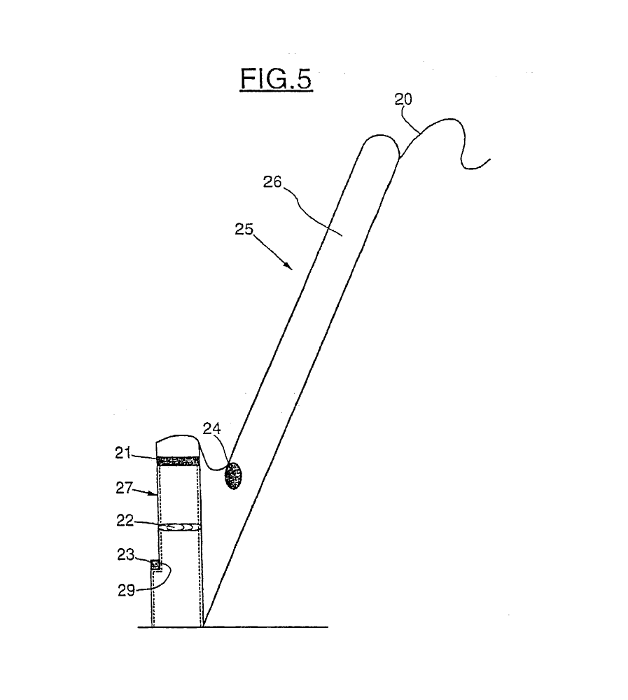

FIG. 5 is a diagrammatic view of a light pen,

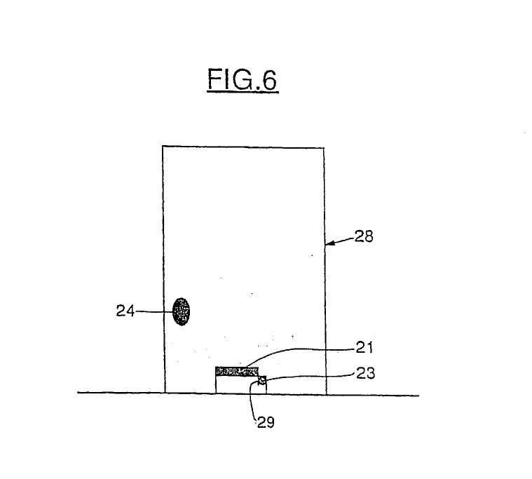

FIG. 6 is a diagrammatic view of a telephone provided with reader means,

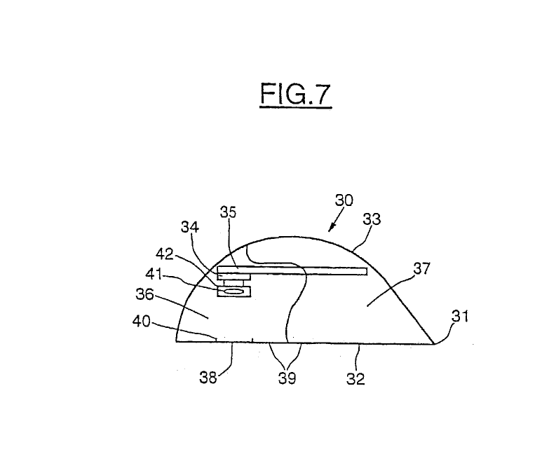

FIG. 7 is a diagrammatic sectional view of one embodiment of a reader device, and

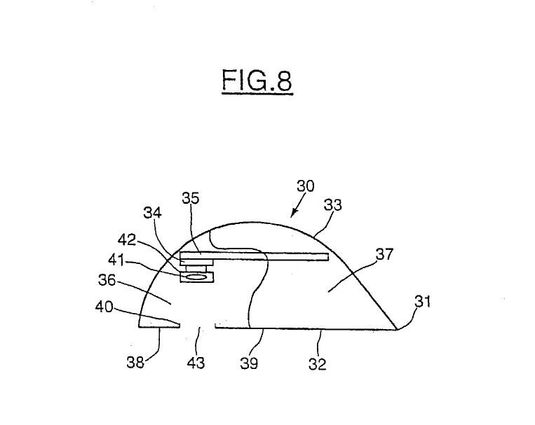

FIG. 8 is a diagrammatic sectional view of another embodiment of a reader device.

The method according to the invention provides automatic access to an Internet address from a pictogram in a printed document, for example. To this end, it is necessary, on the one hand, to generate a pictogram associated with an Internet address and, on the other hand, to read and interpret the pictogram in order to open the Internet address automatically.

By “pictogram” is meant a small (for example 3 mm×3 mm or 5 mm×5 mm) two-dimensional symbol representing a matrix or checkerboard of n contiguous black or white cells with a side length of about 100 microns and including means enabling identification of the orientation of the checkerboard.

Each cell corresponds to a coded information bit, for example white=0, black=1.

One type of pictogram is proposed by the ANSI Data Matrix ECC-200 standard, and enables correction of reading errors using redundant information contained in the checkerboard (Reed-Solomon algorithm).

A pictogram occupies much less room than a conventional bar code because it uses two spatial dimensions.

The expression “pictogram reader” refers to a device for photographically capturing the pictogram and digitally processing the image obtained, to provide at its output the code or information contained in the checkerboard. The function for photographically capturing the pictogram is integrated into a capture peripheral device. The image is preferably processed by a processor unit of a microcomputer or a mobile telephone.

In the embodiment of the invention for opening an Internet address, the “code-address” strings are stored in a web server which collects together all web addresses associated with pictograms for all creators of pictograms. What is referred to hereinafter as the “server” can comprise a single physical entity or a combination of several machines, for example an HTTP server and a separate database server, with CGI links between them, or even banks of database servers.

As can be seen in FIG. 1, a user requiring to create a pictogram in order to be able to use the method according to the invention has access to a computer 1 (for example a PC) with a screen 2 and a keyboard 3 and a printer 4 connected to the computer 1. The computer 1 is able to communicate with a server 5 which is connected to a database 6. Of course, the connections between these units are suitable for transferring computer data. The printer 4 prints out a document 7 carrying a pictogram 8. The computer 1 can also be provided with a mouse, not shown.

First of all, the user requests creation of a web pictogram from the computer 1. This necessitates entering the web address associated with the pictogram to be created, and possibly a password. The computer 1 then sends a message containing a request, the entered web address and, where applicable, the password to the server 5 via a network, for example the Internet or an intranet. The server 5 transmits the message comprising the request, the web address and the password to the database 6, and then generates a code corresponding to a pictogram and stores the web address, the code and, where applicable, the password in the database 6. The server 5 then sends the code to the computer 1 which generates a pictogram from the code. Either at the command of the user or automatically, the computer 1 inserts the pictogram into the file of the document to be printed and sends the file to the printer 4 to print out the document 7 carrying the pictogram 8. The pictogram 8 can be created on a server with a bitmap or vector format.

In other embodiments of the invention, the pictogram 8 is generated for diverse uses, such as pointing to a file on the local station, pointing to a link in the content of an information medium such as a CD-ROM, or starting an action by a network element external to the computer 1.

The present example describes the creation of a pictogram associated with an Internet address. The user requires to insert the pictogram 8 into a file that is in the process of being created and is intended to be published. The pictogram is to be associated with an Internet address. The user launches the function which generates the Internet pictogram from an application for creating the file to be printed (word processor, publishing program, etc.) or using a dedicated application.

To define the address and the password, the user enters the destination of the link to be created (Web address) by means of a dialog box of the pictogram generator tool. Entry can take various forms: direct entry, cut and paste, pointing on an existing page, etc. Also, the dialog box prompts the user to enter an optional password needed for subsequently changing the address associated with the pictogram. The default password can be a password entered the first time the software is used.

After the computer 1 has validated the Web address, the software sends a code generation request to the remote server 5. This request is accompanied by the Web address and the password. The request can be sent regardless of whether a browser is open or not.

On receiving said request, the server 5 generates the bits of the code associated with the Web address in a random or incremental manner. The server 5 then stores the combination of the code, the Web address and the password in the database 6. The server 5 sends the code accompanied by the Web address back to the computer 1, so that generation of the pictogram can be started.

A program running on the computer 1 calculates the orientation bits from the received code, associates them with the code bits, and automatically starts the generation of the pictogram in the form of a file that can be imported into any other type of user application and printed out, for example an EPS or TIFF file.

By default, if the user launches the pictogram generator program from his application, such as a word processor or publishing tool, the pictogram is placed at the location of the cursor in the file intended to be published, for example. The pictogram file can be embedded in the page on which the cursor is located or imported as an attachment file. If the user wishes to move the pictogram 8 displayed on the screen 2 he can simply use the mouse to “drag and drop” it.

If the user launches the pictogram generator program from the generator application, the pictogram file is stored in a chosen folder and subsequently inserted into the file to be published.

FIG. 2 shows an example of a pictogram 8 that can be generated in the manner explained above. The pictogram takes the form of a square matrix with 14 pixels along each side. For obvious reasons (to make the figure clearer) the pictogram is shown here to a larger scale. In reality it could have side lengths of the order of 2 to 5 mm, for example 2.5 mm. Some tolerance on the dimensions of the pictogram must of course be accepted. The tolerance is dictated by printers, photocopiers and other reprographic machines. The size of the pictogram must not in any case exceed the size of the exposure window of the sensor.

In one example, the pictogram comprises 16 cells reserved for framing, four in each corner of the pictogram in areas with dimensions of 2×2 cells. Three of these areas 9 comprise a black cell in a predetermined position, for example right in the corner, and three white cells. The framing area 10 comprises four white cells. Thus the pictogram can be framed and oriented. Furthermore, 18 parity check cells are divided between three areas 11 each comprising six cells. The areas 11 are shaded in FIG. 2 for clarity. Obviously they really comprise black or white cells. The three areas 11 are divided between the first row, the first column and the last column of the pictogram, for example. 68 of the 100 cells remain for the actual coding, catering for 7.38×10¹⁹ values of X.

The system conforming to one aspect of the invention shown in FIG. 3 commands an operation, for example in a computer system, by reading a pictogram.

In this new example, the user needing to read a pictogram is generally not the user responsible for generating the pictogram (see FIG. 1), and has access to a computer 12 with a screen 13 and a keyboard 14. The computer 12 is connected to a sensor 15 by a cable 16. The computer 12 is also connected to the server 5 described above by a data link. The sensor 15, which is a mouse, for example, constitutes pictogram reading means. For more details on the mouse 15, see the passage hereinafter relating to FIG. 4. As an alternative, the cable link 16 can be replaced by a contactless link, for example an infra red or radio link.

This is how the system is used. The user has a document 7 carrying a pictogram 8 and captures the pictogram by placing the sensor 15 over it and commanding its optical capture. The pictogram 8 is then processed by the computer 12 which sends the server 5 a request accompanied by the code read in the pictogram. The server 5 interrogates the database 6 by sending it a request accompanied by the code. The database 6 processes the request by finding the corresponding web address, which it sends to the server 5. The server 5 sends the web address to the computer 12, which then connects to a server, shown in dashed outline, which supplies to the computer the page corresponding to said address.

To be more precise, the user places his capture peripheral device, for example his mouse, on the pictogram 8 and clicks on the appropriate control button of said capture peripheral device. The optical sensor of the peripheral device then takes a digital photograph of the pictogram 8. The picture is transmitted to the computer 12 in digital form and is processed in a manner described later to obtain a code. When the code has been recognized and validated, a routing function determines the application with which the code is associated, for example file opening, Web link, etc. To this end, a particular series of bits is read, for example the first eight bits. Each possible combination of bits corresponds to only one application, for example:

0000001=open file on local station,

0000010=Web link,

0000011=CD-ROM link,

0000100=open electronic mail address,

0000101=telephone number, etc.

Once the application has been recognized, the software launches it.

The opening of a Web address associated with the code from the user's computer 12 is described hereinafter.

When it has recognized the application to which the pictogram relates, it sends an Internet request accompanied by the code to the remote server which holds the “code-address” combination. The request can advantageously be sent in accordance with the HTTP protocol, which requires the control program of the reader to open an Internet browser on the computer 12. In a different situation, the request can be sent without opening the browser. For this, the software relies on programming that is usable directly by the operating system of the computer. If required, it can launch the Internet browser without specifying an address while awaiting a response.

The server 5 receives the search request accompanied by the code and begins a search in the database 6. If it finds the code, it extracts the corresponding address and sends it back to the original user station, namely the computer 12. If it does not find it, it sends an error message. The computer 12 receives the response from the server 5 and then commands opening of the browser with the received address, or displays an error message, possibly with a prompt to try again to capture the pictogram. The software can repeat the request in the event of a lengthy wait for a response. If there is still no response, the software has the browser display a standard error message. Of course, options or default parameters can be offered, for example opening the Web page in a new window for each request.

The reader peripheral device must be sufficiently compact to hold in one hand, like a pencil, or to be incorporated into a computer mouse. At the time of capture, its bottom part, or exposure window, must be flat against the support on which the pictogram 8 is printed. Thus the user places the reader peripheral device on the pictogram before commanding reading thereof by clicking.

To reduce the probability of failure when reading the pictogram 8, it is necessary to use an exposure window about twice the size of the pictogram, for example a 5×5 mm window for a 2.5×2.5 mm pictogram or a 10×10 mm window for a 5×5 mm pictogram. The immediate vicinity of the pictogram 8 must be blank to avoid artifacts liable to induce processing errors. A white margin around the pictogram at least the size of one side of an individual cell, for example about 1 mm, is therefore desirable.

The light reflected by the pictogram enters the reader peripheral device via the exposure window. The reader peripheral device essentially comprises a detector in the form of a photosensitive pixel matrix, for a example a CMOS matrix. The peripheral device can optionally be provided with a device for illuminating the pictogram and/or an optical system for focussing the light reflected from the pictogram.

The ambient natural light may be sufficient to illuminate the pictogram if the exposure window is transparent at the sides. However, the variability of ambient natural light may compromise the response of the CMOS sensor in terms of its signal to noise ratio (SNR). To eliminate this variability, artificial illumination of the pictogram may be imposed, by means of flashed light-emitting diodes placed at the sides of the exposure window to provide uniform illumination of the target field.

The light reflected by the pictogram could be captured without any form of guidance by a detector in the immediate vicinity of the support carrying the pictogram. This is possible only if the diffusion of the reflected light throughout the space by all the points of the pictogram is negligible compared to the resolution required for the captured image, and thus under conditions of extreme closeness to the pictogram. A detection surface a few hundred microns from the pictogram, i.e. at a distance of the same order of magnitude as the pixels of the pictogram, can capture the pictogram image with the possibility of distinguishing white tones and black tones during processing. However, this proximity is accompanied by some obstruction of the illumination of the pictogram.

In one embodiment the photosensitive surface is set back from the pictogram and the reflected light is guided to the detector by an optical system for focussing the light. One or more focussing lenses can generate a usable image without compromising the constraints that impose small depth of the device (for example a depth less than 4 cm).

The photosensitive pixel matrix is preferably a CMOS matrix, which is very suitable in terms of cost, dynamic range, integration and low electrical power consumption. Assuming that the size of the pictogram is half that of the exposure window, the number of CMOS pixels must exceed the number of cells in the pictogram in each direction in the image plane by a factor of at least 6; this is because a factor of 2 is necessary for the size of the field of the exposure window and a factor of 3 is necessary for the oversampling required to eliminate any ambiguity as to the position and the content of the black and white pixels of the pictogram. Accordingly, a 144×144-pixel matrix is sufficient for capturing and processing a pictogram image of 14×14 pixels. In other words, a QCIF 14×14 format webcam (144×176 pixels) can decode such pictograms, provided that appropriate focussing optics are provided.

The acquisition electronics monitor the exposure time and gain of the pixels and read and digitize their signals. The CMOS technology enables all these functions to be incorporated into the pixels themselves, which greatly simplifies the implementation of the electronics and guarantees miniaturization of the capture peripheral device. Monitoring the exposure time and gain of the pixels is of particular benefit if the solution with variable natural lighting is adopted. Real time adjustment of the gain as a function of the quantity of light received by the photosites can then be envisaged.

The framework of the pictogram reader must be compact and can take the form of a pen or a protuberance on a mouse, forming a kind of snout on the mouse, or a protuberance on a telephone handset.

A processor unit, such as that of a computer or a telephone handset, receives the ordered series of the intensities of the pixels of the image coded on k bits from the reader peripheral device, for example via a USB port in the case of a computer. In the general case, and given the present state of the art in CMOS sensors, k=8 bits. A value k=1 can be used if controlled illumination of the pictogram is available. Software extracts the code of the pictogram from the captured intensities. The pictogram is generally off-center and skewed in the captured image. To return it to the correct orientation, it must be possible to identify the virtual grid on which the cells are positioned. Systematic reference points tied to the pictogram are therefore provided (see areas 9 and 10 in FIG. 2).

A simple algorithm frames the pictogram, for example a triangulation algorithm. For example, to identify the black cells in the corners, all the smallest local minimum gray levels of the image are identified and the triplets of cells retained are then searched to find the triplet forming the largest isosceles right-angle triangle, which must correspond to the black corners of the pictogram. If this triplet is found, the position and orientation of the pictogram in the image are known; this process is referred to as transformation (translation and rotation) between the frame of reference of the image and that of the pictogram, so that it becomes a simple matter to extract the strings of black and white tones of the cells of the pictogram. In the case of natural lighting with a sufficient dynamic range, it is sufficient to plot a histogram of the pixel intensities to locate the two peaks characteristic of the white and black tones of the cells of the pictogram. If the triangulation operation fails, processing is interrupted and a message is sent to tell the user that reading of the pictogram has failed.

FIG. 4 shows one example of a reader peripheral device taking the form of a mouse 17. The mouse 17 has an oblong body 18 with a plane bottom face 19. At the rear of the body 18 is a cable 20 connected to a computer, not shown. The transducer generally incorporated in the mouse, which projects from its bottom face 19 and generally takes the form of a ball, can be of a conventional type and is not shown either.

The CMOS sensor matrix 21 is at the front of the mouse, at a particular distance from the bottom surface 19. A lens 22 on the optical path between the bottom surface 19 and the matrix 21 focuses light reflected by the surface which carries a pictogram. Opaque edges are provided around the lens 22. Light-emitting diodes 23 are optionally provided for illuminating the pictogram to be read. An optical separator 29 is placed near the diode 23 to prevent direct propagation of light emitted by the diode 23 toward the matrix 21.

Finally, a button 24 on the body 18 which can be clicked commands reading by the matrix 21 simultaneously with illumination by the light-emitting diode 23. A plurality of light-emitting diodes can be provided.

When the user clicks the button 24, a digital photograph of the pictogram is taken by the matrix 21 and sent in digital form to the computer system for processing. The button 24 is dedicated to the pictogram reading function in order for this function to be recognized by the computer system. Reading can be carried out independently of the software running on the computer, or more generally on the computer system.

FIG. 5 shows a variant of the reader means taking the form of a light pen 25 which also has a cable 20 and comprises a handle 26 at one end of which there is a reading assembly 27 formed as in the previous embodiment by a CMOS pixel matrix 21, a lens 22 and an optional light-emitting diode 23. The light pen 25 is particularly suitable for data processing tools such as fixed or portable computers, etc. An image of the pictogram is captured by placing the light pen 25 on the pictogram and clicking a button 24 on the body of the pen.

FIG. 6 shows a variant in which the reader means are incorporated into a device 28 such as a telephone handset, a personal digital assistant, a pager or a remote controller. The device 28 is shown diagrammatically as a rectangle and integrates a function equivalent to that of the light pen in addition to its own functions, which are not shown. This function can be particularly useful if the device 28 is used as an Internet terminal (Web, electronic mail).

As before, there are provided a CMOS pixel matrix 21 and an optional light-emitting diode 23. The matrix 21 is near an outside surface of the device 28 so that the light path between the pictogram to be read and the matrix 21 is short. A control button 24 is also provided. The image is captured by placing the optical reader means of the device 28 over the pictogram and clicking the button 24. The data processing unit is integrated into the device 28. However, image processing and decoding can be carried out remotely in another unit, following transfer over a high bit rate wireless link, for example a link conforming to the Bluetooth standard. The button 24 is dedicated to the pictogram reading function in order for this function to be recognized by the computer system. As an alternative to this, the user could enter a particular code via the keyboard of the device 28 to start reading.

FIG. 7 shows a reader device 30 which includes a casing 31 with a plane bottom wall 32 and a convex top wall 33, a CMOS optical sensor 34 and a processor card 35 connected to the sensor. The sensor 34 can be integrated into the processor card 35. The processor card 35 can be equipped with an output port, not shown. Send/receive means for remote exchange of data can be connected to the output of the card or integrated into the card. A cable connection is also an option.

The sensor 34 is on top of the bottom wall 32 of the casing 31 and fastened to said casing 31. The top wall 33 of the casing 31 has a translucent or transparent portion 36 and possibly an opaque portion 37. The translucent or transparent portion 36 is near the sensor 34 so that a surface which can be read by the sensor 34 receives light via said translucent or transparent portion 36.

Similarly, the bottom wall 32 of the casing 31 has a translucent or transparent portion 38 and possibly an opaque portion 39. The translucent or transparent portion 38 of the bottom wall. 32 is placed in the optical field of the sensor 34 so that a surface which can be read by the sensor 34 receives light via said translucent or transparent portion 38.

The bottom wall 32 is solid, which prevents the ingress of foreign bodies, in particular dust. Of course, the bottom and top walls can be entirely translucent or transparent. The translucent or transparent portions make the ambient lighting, whether natural or artificial, sufficient for the sensor 34.

Furthermore, the casing 31 carries visual markings 40 for assisting the user to place the device relative to a surface from which an image is to be acquired. The visual markings are obtained by applying marks to the translucent or transparent portion of the bottom wall of the casing, for example by means of a printing or screenprinting process. As an alternative to this, a three-dimensional pattern can be provided in the translucent or transparent portion, for example a groove or a rib. The opaque portion can equally well serve as a reference mark. The reference mark must have a square contour with a thickness of the order of 0.2 to 2 mm, corresponding to the field of the sensor, so that the user can position the device relative to a surface, by causing the visual markings to line up with an area of the surface of which an image is to be acquired, and acquire said area.

All or part of the visual markings can be in the field of the optical sensor.

A lens 41 is mounted upstream of the sensor 34, in the direction of propagation of the reflected light, by means of an opaque frame 42, and is in the field of the sensor 34. The lens is not essential in all applications, however. An economical variant can dispense with the lens. The image is then transmitted directly to the sensor 34, provided that the sensor is very close to the object.

In the variant shown in FIG. 8, the bottom wall 32 includes a hole 43 in the field of the sensor 34. The hole 43 favors the transmission of light. The edges of the hole can carry colored markings contrasting with the remainder of the bottom wall 32.

Another variant, not shown, would be to provide a supplementary cylindrical or frustoconical wall between the hole in the bottom wall and the sensor.

The present invention is particularly useful in that it provides an extremely simple and efficient manner of opening computer applications, in particular Web sites. It is of great benefit in the field of advertising, because a user interested in an advertisement on a written medium can immediately read off the pictogram in a local area of the advertisement and connect to the corresponding Web page or receive a corresponding electronic mail message.

The invention also applies to telephones, especially cordless and mobile telephones, and retains access to a telephone number from a business card, for example, even if the number has changed. A telephone number can also be stored or dialed from a list printed on paper, a label affixed to another telephone handset, or any other type of medium.

The invention enables an entity sending or creating information to make the information available to a user via a host hosting a database associating the pictogram code and a Web address.

1. A system for commanding an operation, the system including a reader device (15) and a digital processor unit (12) connected to the reader device, the reader device including an optical sensor (21) adapted to read coded information in the form of a two-dimensional pictogram (8) on a surface on which said device rests, and said information being transmitted to the digital processor unit to trigger a computer operation, characterized in that the processor unit includes means for sending a control code to a database, on reception of said information, the database including means for outputting an Internet request or an address in response to said control code.

2. A system according to claim 1, characterized in that the reader device is part of a mouse (17) provided with means for sensing movement relative to a surface.

3. A system according to claim 1, characterized in that the reader device is part of a light pen (25).

4. A system according to claim 1, characterized in that the reader device is part of a telephone (28), a pager, a personal digital assistant, a remote controller, or a webcam.

5. A system according to any preceding claim, characterized in that the database or the digital processor unit is adapted to launch a request to open a destination designated by said address or any other Internet or digital operation.

6. A system according to any preceding claim, characterized in that the optical sensor is a CMOS optical sensor.

7. A system according to any preceding claim, characterized in that the optical sensor is able to read coded information when it is immobile relative to said surface, the reader device being in contact with said surface.

8. A method of commanding an operation, in which a reader device, including an optical reader sensor, reads coded information in the form of a two-dimensional pictogram on a surface on which said device rests and transmits said information to a digital processor unit connected to said device to trigger a computer operation, on receipt of said information, a digital processor unit connected to said device sends a control code to an external database and, in response to said control code, the external database sends back an Internet instruction.

9. A method according to claim 8, wherein the external database sends back an Internet site address to launch a request to open the site on the digital processor unit.

10. A reader device (15) including an optical sensor (21) able to read coded information in the form of a two-dimensional pictogram (8) in an area of a surface when said area is disposed in the field of the optical sensor, and means for transmitting said information to a digital processor unit, characterized in that it further includes illumination means for illuminating said area using ambient light.

11. A device according to claim 10, characterized in that the illumination means comprise a translucent or transparent portion of a casing containing the optical sensor.

12. A device according to claim 10 or claim 11, characterized in that it comprises aiming means for positioning the device correctly relative to the field of the optical sensor, which is fixed relative to the device.

13. A device according to claim 12, characterized in that the aiming means comprise visual markings around and/or in the field of the optical sensor.

14. A computer program comprising program code means for implementing the steps of the method according to either claim 9 or claim 10 when said program is executed on a computer.

15. A medium capable of being read by a device for reading program code means stored therein and adapted to implement the steps of the method according to either claim 9 or claim 10 when said program is executed on a computer.
